(19) United States
(12) Patent Application Publication
(10) Pub. No.: US 2013/0321531 A1
(43) Pub. Date: Dec. 5, 2013

(54) RING-TYPE HEATING RESISTOR FOR THERMAL FLUID-EJECTION MECHANISM

(71) Applicants: Peter Mardilovich, Corvallis, OR (US); Lawrence H. White, Corvallis, OR (US); Erik D. Torniainen, Albany, OR (US)

(72) Inventors: Peter Mardilovich, Corvallis, OR (US); Lawrence H. White, Corvallis, OR (US); Erik D. Torniainen, Albany, OR (US)

(21) Appl. No.: 14/000,622

(22) PCT Filed: Mar. 1, 2011
(86) PCT No.: PCT/US11/26732

§ 371 Date: Aug. 21, 2013

(51) Int. Cl. B41J 2/14

(52) U.S. Cl. CPC B41J 2/1412
USPC 347/62

(57) ABSTRACT

A ring-type heating resistor for a thermal fluid-ejection mechanism includes resistive segments and conductive segments. The resistive segments are rectangular in shape. The resistive segments are separated from one another. The conductive segments are interleaved in relation to the resistive segments such that each conductive segment electrically connects two of the resistive segments. The resistive segments and the conductive segments together form a pseudo-ring that approximates a true ring.

### BACKGROUND

One type of printing device is a thermal inkjet-printing device. A thermal inkjet-printing device forms images on media like paper by thermally ejecting drops of fluid onto the media in correspondence with the images to be formed on the media. The drops of fluid are thermally ejected from the thermal inkjet-printing device by using a heating resistor. When electrical power is applied to the heating resistor, the resistance of the heating resistor causes the resistor to increase in temperature. This increase in temperature causes a bubble to be formed, which results in the drops of fluid being ejected.

### BRIEF DESCRIPTION OF THE DRAWINGS

FIG. 1A is a top view diagram of an example ring-type heating resistor for a thermal fluid-ejection mechanism.

FIGS. 1B and 1C are top view diagrams of different example ring-type heating resistors, in which conductive leads are explicitly depicted.

FIG. 2 is a cross-sectional side view diagram of an example of a thermal fluid-ejection mechanism including a ring-type heating resistor.

FIG. 3 is a block diagram of an example of a rudimentary thermal fluid-ejection device.

### DETAILED DESCRIPTION

As noted in the background section, a thermal inkjet-printing device ejects drops of fluid onto media by applying electrical power to a heating resistor, which ultimately results in the drops of ink being ejected. A thermal inkjet-printing device is one type of thermal fluid-ejection device that employs heating resistors to thermally eject fluid. Most traditionally, a heating resistor has been in the shape of a rectangle.

Other shapes of heating resistors may improve the efficiency of the heating resistor and of the thermal fluid-ejection device itself. However, deviating from the basic rectangular shape may be disadvantageous, even in light of the resulting improved efficiency. For instance, electrical current may become concentrated in certain areas of a heating resistor, resulting in uneven heating that is undesirable, and worse, potential long-term reliability problems.

Disclosed herein is a ring-type heating resistor that avoids these and other problems of alternative heating resistor designs, while still improving efficiency as compared to the basic rectangular shape for a heating resistor. The ring-type heating resistor includes resistive segments and conductive segments interleaved in relation to one another. The resistive segments are rectangular in shape, and are separated from one another such that each resistive segment may not be in contact with any other resistive segment. Each conductive segment electrically connects two resistive segments.

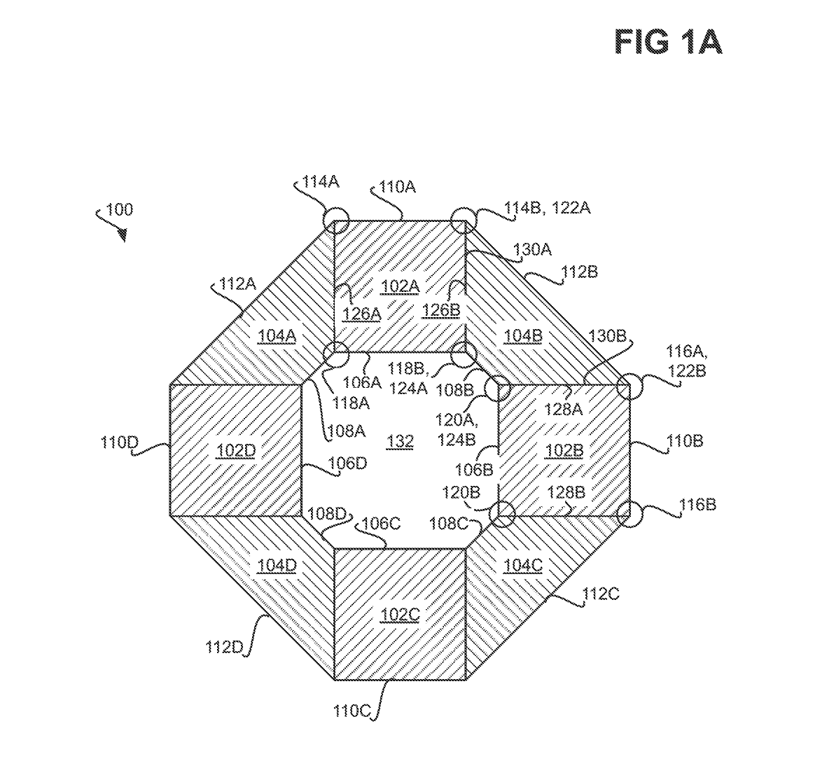

FIG. 1A shows a top view of an example ring-type heating resistor 100. The heating resistor 100 includes resistive segments 102A, 102B, 102C, and 102D, collectively referred to as the resistive segments 102. The resistive segments 102 may be formed from tantalum-aluminum, tungsten-silicon nitride, tantalum-silicon nitride, or another type of resistive material. The resistor 100 also includes conductive segments 104A, 104B, 104C, and 104D, collectively referred to as the conductive segments 104. The conductive segments 104 may be formed from aluminum, copper, gold, silver, platinum, a combination thereof, or another type of conductive material.

The resistive segments 102 are resistive in that they are considered resistors that have greater resistance than that of the conductive segments 104. Likewise, the conductive segments 104 are conductive in that they are considered conductors that have greater conductance than that of the resistive segments 102. The resistance of the resistive segments 102 is many times greater than the resistance of the conductive segments 104; as one example, this resistance ratio may be 5000 or higher. Likewise, the conductance of the conductive segments 104 is many times greater than the conductance of the resistive segments 102; as one example, this conductance ratio may be 5000 or higher.

As noted above, the conductive segments 104 are interleaved with the resistive segments 102. That is, each conductive segment 104 electrically connects two resistive segments 102. The resistive segments 102 are separated from one another. As such, each resistive segment 102 is not in direct contact with any other resistive segment 102. The resistive segments 102 can be even in number, or may be odd in number, and are equal in number to the conductive segments 104. The resistive segments 102 and the conductive segments 104 together form a pseudo-ring. The ring is a pseudo-ring and not a true ring insofar as a true ring has curved surfaces, whereas the pseudo-ring formed by the segments 102 and 104 do not. As such, it can be said that the pseudo-ring formed by the segments 102 and 104 approximate a true ring, depending on the number of segments 102 and 104.

As evidenced by FIG. 1A, this pseudo-ring may be symmetrical about an axis perpendicular to FIG. 1A intersecting a center point of the area 132. The pseudo-ring may be symmetrical about other axes as well.

The resistive segments 102A, 102B, 102C, and 102D have interior edges 106A, 106B, 106C, and 106D, respectively, which are collectively referred to as the interior edges 106. Likewise, the conductive segments 104A, 104B, 104C, and 104D have interior edges 108A, 108B, 108C, and 108D, respectively, which are collectively referred to as the interior edges 108. The resistive segments 102A, 102B, 102C, and 102D also have exterior edges 110A, 110B, 110C, and 110D, respectively, which are collectively referred to as the exterior edges 110. Likewise, the conductive segments 104A, 104B, 104C, and 104D also have exterior edges 112A, 112B, 112C, and 112D, respectively, which are collectively referred to as the exterior edges 112.

The exterior edges 110 and the interior edges 106 of the resistive segments 102 are substantially or at least substantially identical in length. This is because the resistive segments 102 are rectangular in shape, and may be square. By comparison, the exterior edges 112 of the conductive segments 104 are greater in length than the interior edges 108. This is because the conductive segments 104 are trapezoidal in shape. Where the formed pseudo-ring is symmetrical, the exterior edges 112 are substantially or at least substantially identical in length, and the interior edges 108 are substantially or at least substantially identical in length. However, in other situations the formed pseudo-ring may be asymmetrical.

The pseudo-ring formed by the resistive segments 102 and the conductive segments 104 is said to have first exterior facets corresponding to the exterior edges 110 of the resistive segments 102, and second exterior facets corresponding to the exterior edges 112 of the conductive segments 104. The pseudo-ring is also said to have first interior facets corresponding to the interior edges 106 of the resistive segments 102, and second interior facets corresponding to the interior facets 108 of the conductive segments 104. The pseudo-ring thus approximates but is not a circle (or other type of true ring).

The pseudo-ring of the ring-type heating resistor 100 formed by the resistive segments 102 and the conductive segments 104 approximates a true ring in that it has an exterior edge made up of the first and second exterior facets, and also has an interior edge made up of the first and second interior facets. By comparison, a heating resistor that has an exterior edge but not an interior edge is not a ring-type heating resistor, but rather is just a polygon, or a circular or oval disc, having no interior edge. The ring-type heating resistor 100 can be said to have a central area 132 that is surrounded, encompassed, and/or encircled by the resistive segments 102 and the conductive segments 104 forming the pseudo-ring. This central area 132 is devoid of any portion of the segments 102 and 104.

The example ring-type heating resistor 100 depicted in FIG. 1A specifically includes four resistive segments 102 and four conductive segments 104, such that the pseudo-ring has eight exterior facets and eight interior facets. However, the heating resistor 100 may have more than four resistive segments 102 and more than four conductive segments 104, such as six of each type of segment 102 and 104, eight of each type of segment 102 and 104, and so on, where there can be an even number, or an odd number, of resistive segments 102. The greater the number of the segments 102 and 104, the more the resulting pseudo-ring approximates a circle (i.e., a true ring) at its exterior edge and at its interior edge.

The remainder of the description of FIG. 1A is made in relation to the resistive segments 102A and 102B as representative of all the resistive segments 102, and in relation to the conductive segment 104B as representative of all the conductive segments 104. The resistive segment 102A has a pair of exterior corners 114A and 1148, collectively referred to as the exterior corners 114, and the resistive segment 102B likewise has a pair of exterior corners 116A and 1168, collectively referred to as the exterior corners 116. The resistive segment 102A also has a pair of interior corners 118A and 1188, collectively referred to as the interior corners 118, and the resistive segment 1188 likewise also has a pair of interior corners 120A and 120B, collectively referred to as the interior corners 120.

The exterior edge 110A of the resistive segment 102A is defined between the exterior corners 114, and thus extends from the exterior corner 114A to the exterior corner 1148 and vice-versa. Likewise, the exterior edge 1108 of the resistive segment 1028 is defined between the exterior corners 116, and thus extends from the exterior corner 116A to the exterior corner 1168 and vice-versa. The interior edge 106A of the resistive segment 102A is defined between the interior corners 118, and thus extends from the interior corner 118A to the interior corner 1188 and vice-versa. Likewise, the interior edge 106B of the resistive segment 102B is defined between the interior corners 120, and thus extends from the interior corner 120A to the interior corner 120B and vice-versa.

The resistive segment 102A has side edges 126A and 126B, collectively referred to as the side edges 126, and the resistive segment 102B likewise has side edges 128A and 128B, collectively referred to as the side edges 128. The side edge 126A is defined between the interior corner 118A and the exterior corner 114A, and thus extends from the interior corner 118A to the exterior corner 114A and vice-versa. The side edge 126B is defined between the interior corner 1188 and the exterior corner 1148, and thus extends from the interior corner 1188 to the exterior corner 1148 and vice-versa. The side edge 128A is defined between the interior corner 120A and the exterior corner 116A, and thus extends from the interior corner 120A to the exterior corner 116A and vice-versa. The side edge 128B is defined between the interior corner 1208 and the exterior corner 1168, and thus extends from the interior corner 1208 to the exterior corner 1168 and vice-versa.

The conductive segment 1048 has a pair of exterior corners 122A and 1228, collectively referred to as the exterior corners 122. The exterior corner 122A is coincidental with the exterior corner 1148 of the resistive segment 102A, and the exterior corner 122B is coincidental with the exterior corner 116A of the resistive segment 1028. The conductive segment 1048 also has a pair of interior corners 124A and 1248, collectively referred to as the interior corners 124. The interior corner 124A is coincidental with the interior corner 1188 of the resistive segment 102A, and the interior corner 1248 is coincidental with the interior corner 120A of the resistive segment 1028.

The conductive segment 1048 has a pair of side edges 130A and 130B, collectively referred to as the side edges 130. The side edge 130A is defined between the interior corner 124A and the exterior corner 122A, and thus extends from the interior corner 124A to the exterior corner 122A and vice-versa. The side edge 130A is collinear with the side edge 126B of the resistive segment 102A. The side edge 130B is defined between the exterior corner 124B and the exterior corner 122B, and thus extends from the interior corner 124B to the exterior corner 122B and vice-versa. The side edge 130B is collinear with the side edge 128A of the resistive segment 1028.

The side edges 130 are substantially identical in length to the side edges 126 of the resistive segment 102A and to the side edges 128 of the resistive segment 1028. The side edge 130A of the conductive segment 1048 is said to contact the side edge 1268 of the resistive segment 102A. The side edge 1308 of the conductive segment 1048 is said to contact the side edge 128A of the resistive segment 1028. Therefore, in some scenarios, the side edges 130 may be identical.

When electrical power is applied to the ring-type heating resistor 100 that has been described, the heating resistor 100 has certain advantageous characteristics. Heating of the resistive segments 102 is uniform. This is because electrical current flows through each resistive segments 102 uniformly. For instance, because the side edges 126 and 128 of the resistive segments 102A and 102B are substantially or at least substantially identical in length to the side edges 130 of the conductive segment 1048, electrical current exits or enters the resistive segments 102A and 102B across their entire side edges 126 and 128. It has also been found that in most cases having even numbers of resistive segments 102 results in more uniform heating of the heating resistor 100 (and hence of the fluid that is ultimately in contact with the resistor 100) than odd numbers of resistive segments 102.

In the ring-type heating resistor 100, the elements thereof that have interior edges that are shorter in length than their exterior edges—so that a pseudo-ring can be formed—are the conductive segments 104 and not the resistive segments 102, which by comparison have interior edges 106 that are substantially identical in length to their exterior edges 110. In some scenarios, if the resistive segments 102 have interior edges 106 that are substantially shorter in length than their exterior edges 110, then electrical current would not flow uniformly through the resistive segments 102, which would result in undesired uneven heating of each resistive segment 102. The conductive segments 104 do not have this issue, because the segments 104 are conductors.

FIGS. 1B and 1C are top view diagrams of different examples of the ring-type heating resistor 100, in which conductive leads 152A and 152B, collectively referred to as the conductive leads 152, are explicitly depicted. Both FIGS. 1B and 1C show the resistive segments 102 and the conductive segments 104. In FIG. 1B, the conductive segment 104A has been divided into two separate parts 154A and 154B. In FIG. 1B, the conductive lead 152A is part of or is otherwise electrically connected to part 154A of the conductive segment 104A, and the conductive lead 152B is part of or is otherwise electrically connected to part 154B of the conductive segment 104A. In FIG. 1C, the conductive lead 152A is part of or is otherwise electrically connected to the conductive segment 104A, and the conductive lead 152B is part of or is otherwise electrically connected to the conductive segment 104C.

In FIG. 1B, the resistive segments 102 are connected in serial with one another between the conductive leads 152. For example, electrical current passes from the conductive lead 152A, through the resistive segments 102A, 102B, 102C, and 102D in order, and then returns into the conductive lead 152B. By comparison, in FIG. 1C, the resistive segments 102 are connected in two branches 156A and 156B that are in parallel with one another between the conductive leads 152. For example, electrical current passes from the conductive lead 152A to the conductive lead 152B in the branch 156A that includes the resistive segments 102A and 102B, and also passes from the conductive lead 152A to the conductive lead 152B in the branch 156B that includes the resistive segments 102D and 102C.

In the ring-type heating resistor 100 depicted in the examples of FIGS. 1A, 1B, and 1C, there are four resistive segments 102. However, there may be other numbers of resistive segments 102 as well. For instance, there may be eight resistive segments 102. In this example, the eight resistive segments 102 may be connected in serial with one another, as in FIG. 1B, or they may be connected in parallel branches 156, as in FIG. 1C. In general, the number and size of the resistive segments 102 is based on the amount of resistance to generate a desired electrical pulse to fire the thermal-fluid ejection mechanism of which the heating resistor 100 is a part, so that the desired drop mass of fluid droplets ejected from the mechanism is obtained.

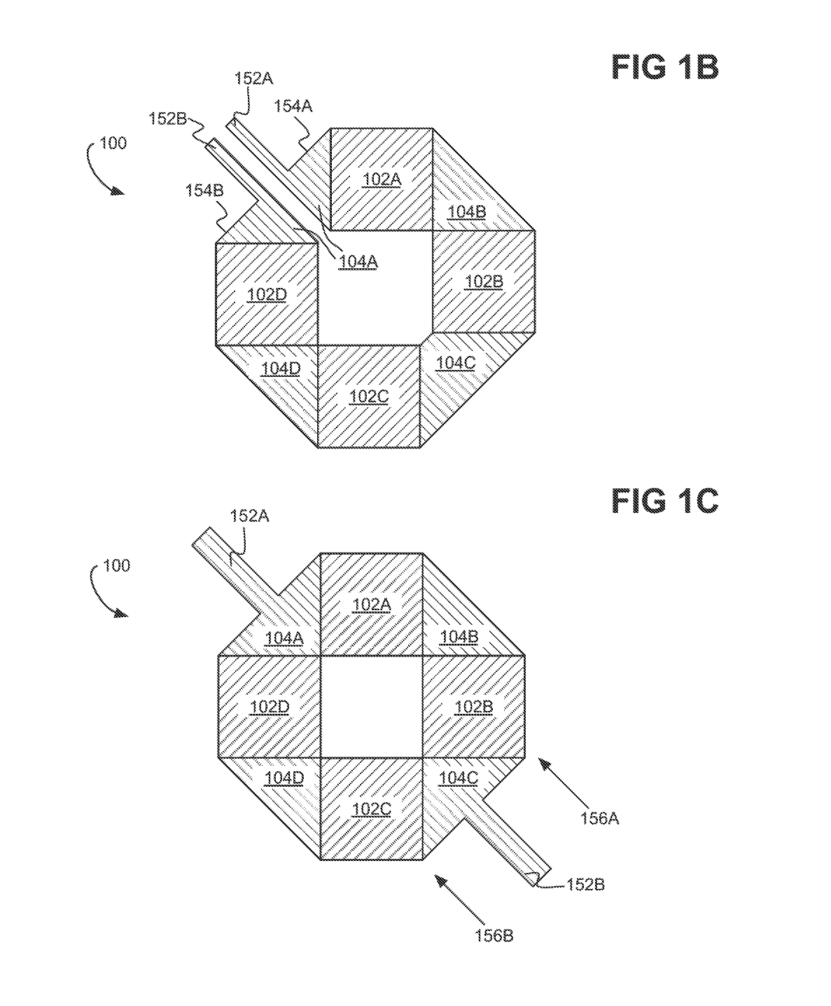

FIG. 2 shows a cross-sectional side view of an example of a thermal fluid-ejection mechanism 200. The thermal fluid-ejection mechanism 200 may be part of a fluid-ejection printhead, for instance, which includes a number of such mechanisms 200. The fluid-ejection mechanism 200 includes a substrate 202, sidewalls 204, and an orifice plate 206. The ring-type heating resistor 100 may be disposed in or on the substrate 202.

The substrate 202, the sidewalls 204, and the orifice plate 206 together define a fluid chamber 208. The orifice plate 206 defines an outlet 210, and the substrate 202 defines an inlet 212, although the inlet 212 may instead be defined within one of the sidewalls 204 as well. Fluid enters into the fluid chamber 208 through the inlet 212 and is stored within the chamber 208 until the heating resistor 100 is heated to cause one or more drops of fluid to be thermally ejected through the outlet 210.

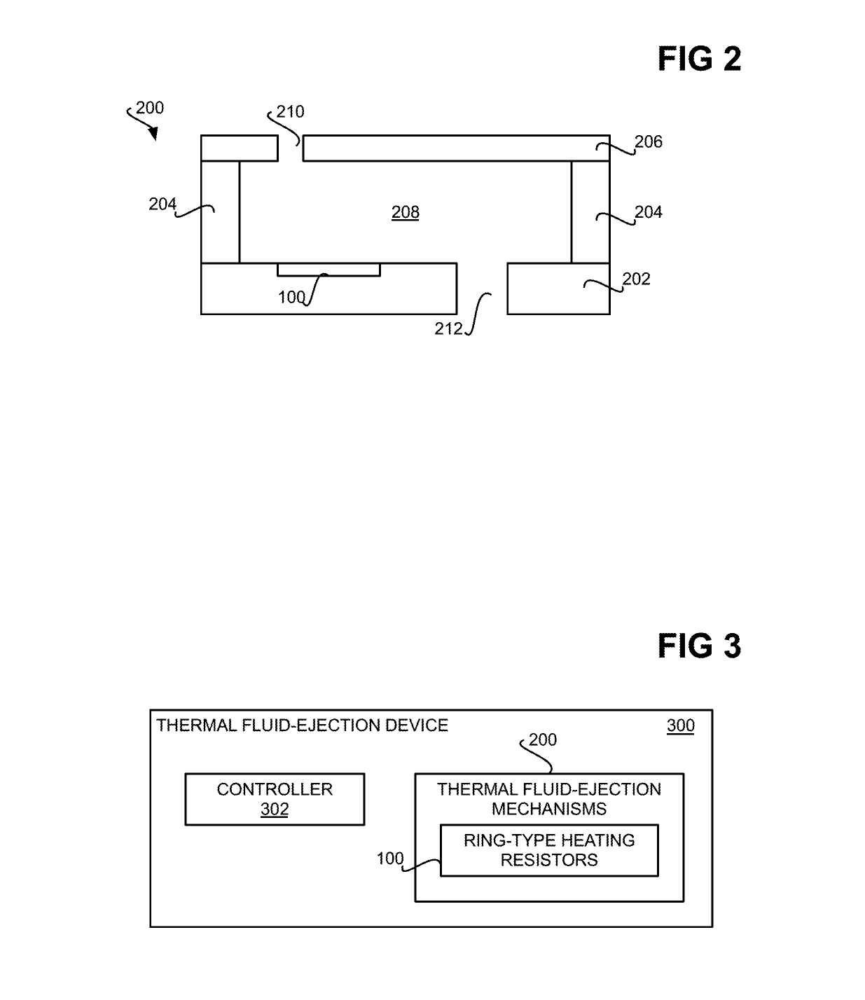

In conclusion, FIG. 3 shows block diagram of an example thermal fluid-ejection device 300. The thermal fluid-ejection device 300 includes a controller 302 and a number of the thermal fluid-ejection mechanisms 200. The controller 302 may be implemented in hardware, or a combination of machine-readable instructions and hardware, and controls ejection of drops of fluid from the fluid-ejection device 300 in a desired manner by the fluid-ejection mechanisms 200. The fluid-ejection mechanisms 200 themselves may be disposed with one or more fluid-ejection printheads. The fluid-ejection mechanisms 200 include ring-type heating resistors 100, as has been described in relation to FIG. 2.

It is noted that the fluid-ejection device 300 may be an inkjet-printing device, which is a device, such as a printer, that ejects ink onto media, such as paper, to form images, which can include text, on the media. The fluid-ejection device 300 is more generally a fluid-ejection, precision-dispensing device that precisely dispenses fluid, such as ink, melted wax, or polymers. The fluid-ejection device 300 may eject pigment-based ink, dye-based ink, another type of ink, or another type of fluid. Examples of other types of fluid include those having water-based or aqueous solvents, as well as those having non-water-based or non-aqueous solvents. However, any type of fluid-ejection, precision-dispensing device that dispenses a substantially liquid fluid may be used.

A fluid-ejection precision-dispensing device is therefore a drop-on-demand device in which printing, or dispensing, of the substantially liquid fluid in question is achieved by precisely printing or dispensing in accurately specified locations, with or without making a particular image on that which is being printed or dispensed on. The fluid-ejection precision-dispensing device precisely prints or dispenses a substantially liquid fluid in that the latter is not substantially or primarily composed of gases such as air. Examples of such substantially liquid fluids include inks in the case of inkjet-printing devices. Other examples of substantially liquid fluids thus include drugs, cellular products, organisms, fuel, and so on, which are not substantially or primarily composed of gases such as air and other types of gases, as can be appreciated by those of ordinary skill within the art.

We claim:

1. A ring-type heating resistor for a thermal fluid-ejection mechanism, comprising:
a plurality of resistive segments, the resistive segments being rectangular in shape, the resistive segments separated from one another; and,
a plurality of conductive segments interleaved in relation to the resistive segments such that each conductive segment electrically connects two of the resistive segments,
wherein the resistive segments and the conductive segments together form a pseudo-ring that approximates a true ring.

2. The ring-type heating resistor of claim 1, wherein the resistive segments are even in number and equal in number to the conductive segments.

3. The ring-type heating resistor of claim 1, wherein the pseudo-ring is symmetrical.

4. The ring-type heating resistor of claim 1, wherein each resistive segment has an exterior edge defined by a pair of exterior corners, and each resistive segment has an interior edge defined by a pair of interior corners,
wherein each conductive segment has an exterior edge and an interior edge,
and wherein the pseudo-ring formed by the resistive segments and the conductive segments has a plurality of first exterior facets corresponding to the exterior edges of the resistive segments, a plurality of second exterior facets corresponding to the exterior edges of the conductive segments, a plurality of first interior facets corresponding to the interior edges of the resistive segments, and a plurality of second interior facets corresponding to the interior edges of the conductive segments.

5. The ring-type heating resistor of claim 1, wherein each resistive segment has a pair of exterior corners and a pair of interior corners,
and wherein the conductive segments are trapezoidal in shape, each conductive segment has an interior edge extending from one interior corner of one of the resistive segments to one interior corner of another of the resistive segments, and has an exterior edge extending from one exterior corner of the one of the resistive segments to one exterior corner of the another of the resistive segments.

6. The ring-type heating resistor of claim 1, wherein each resistive segment has a pair of side edges, the side edges of the resistive segments being substantially equal in length,
wherein each conductive segment has a pair of side edges, the side edges of the conductive segments being substantially equal in length to the side edges of the resistive segments,
and wherein each side edge of each conductive segment contacts one side edge of one of the resistive segments.

7. The ring-type heating resistor of claim 1, further comprising a plurality of conductive traces, each conductive trace electrically connected to or part of a corresponding conductive segment, such that the resistive segments are electrically connected in one of:
a serial manner between the conductive traces; and,
a plurality of branches that are in parallel between the conductive traces.

8. A thermal fluid-ejection mechanism for a thermal fluid-ejection device, comprising:
an orifice plate defining an outlet from which fluid is thermally ejected in drops;
a plurality of sidewalls and a substrate, where the orifice plate, the sidewalls and the substrate defining a fluid chamber in which the fluid is located prior to thermal ejection through the outlet, and where one of the sidewalls and the substrate having an inlet to receive the fluid into the fluid chamber; and,
a ring-type heating resistor on or within the substrate and comprising:
a plurality of resistive segments, the resistive segments being rectangular in shape, the resistive segments separated from one another; and,
a plurality of conductive segments interleaved in relation to the resistive segments such that each conductive segment electrically connects two of the resistive segments,
wherein the resistive segments and the conductive segments together form a pseudo-ring that approximates a true ring.

9. The thermal fluid-ejection mechanism of claim 8, wherein each resistive segment has an exterior edge defined by a pair of exterior corners, and each resistive segment has an interior edge defined by a pair of interior corners,
wherein each conductive segment has an exterior edge and an interior edge,
and wherein the pseudo-ring formed by the resistive segments and the conductive segments has a plurality of first exterior facets corresponding to the exterior edges of the resistive segments, a plurality of second exterior facets corresponding to the exterior edges of the conductive segments, a plurality of first interior facets corresponding to the interior edges of the resistive segments, and a plurality of second interior facets corresponding to the interior edges of the conductive segments.

10. The thermal fluid-ejection mechanism of claim 8, wherein each resistive segment has a pair of exterior corners and a pair of interior corners,
and wherein the conductive segments are trapezoidal in shape, each conductive segment has an interior edge extending from one interior corner of one of the resistive segments to one interior corner of another of the resistive segments, and has an exterior edge extending from one exterior corner of the one of the resistive segments to one exterior corner of the another of the resistive segments.

11. The thermal fluid-ejection mechanism of claim 8, wherein each resistive segment has a pair of side edges, the side edges of the resistive segments being substantially equal in length,
wherein each conductive segment has a pair of side edges, the side edges of the conductive segments being substantially equal in length to the side edges of the resistive segments,
and wherein each side edge of each conductive segment contacts one side edge of one of the resistive segments.

12. A thermal fluid-ejection device comprising:
a plurality of thermal fluid-ejection mechanisms to thermally eject fluid in drops, each thermal fluid-ejection mechanism comprising a ring-type heating resistor; and,
a controller to control thermal ejection of the fluid by the thermal fluid-ejection mechanisms,
wherein each ring-type heating resistor comprises:
a plurality of resistive segments, the resistive segments being rectangular in shape, the resistive segments separated from one another; and,
a plurality of conductive segments interleaved in relation to the resistive segments such that each conductive segment electrically connects two of the resistive segments, the resistive segments and the conductive segments together forming a pseudo-ring that approximates a true ring.

13. The thermal fluid-ejection device of claim 12, wherein within each ring-type heating resistor, the resistive segments are even in number and equal in number to the conductive segments, and the pseudo-ring is symmetrical.

14. The thermal fluid-ejection device of claim 12, wherein within each ring-type heating resistor, each resistive segment has an exterior edge defined by a pair of exterior corners, and each resistive segment has an interior edge defined by a pair of interior corners,
wherein each conductive segment has an exterior edge and an interior edge,
and wherein the pseudo-ring formed by the resistive segments and the conductive segments has a plurality of first exterior facets corresponding to the exterior edges of the resistive segments, a plurality of second exterior facets corresponding to the exterior edges of the conductive segments, a plurality of first interior facets corresponding to the interior edges of the resistive segments, and a plurality of second interior facets corresponding to the interior edges of the conductive segments.

15. The thermal fluid-ejection device of claim 12, wherein within each ring-type heating resistor, each resistive segment has a pair of exterior corners, a pair of interior corners, and a pair of side edges, the side edges of the resistive segments being substantially equal in length,
wherein the conductive segments has a pair of side edges and are trapezoidal in shape, the side edges of the conductive segments being equal in length to the side edges of the resistive segments, each side edge of each conductive segment contacts one side edge of one of the resistive segments, and each conductive segment has an edge extending from one interior corner of one of the resistive segments to one interior corner of another of the resistive segments, and an exterior edge extending from one exterior corner of the one of the resistive segments to one exterior corner of the another of the resistive segments.
